(19) United States
(12) Patent Application Publication
(10) Pub. No.: US 2026/0171552 A1
(43) Pub. Date: Jun. 18, 2026

(54) BATTERY COOLING CIRCUIT AND METHOD OF CONTROLLING THE SAME

(71) Applicants: HYUNDAI MOTOR COMPANY, SEOUL (KR); KIA CORPORATION, SEOUL (KR)

(72) Inventor: Myung Hwan Kim, Hwaseong-si (KR)

(73) Assignees: HYUNDAI MOTOR COMPANY, SEOUL (KR); KIA CORPORATION, SEOUL (KR)

(21) Appl. No.: 19/231,364

(22) Filed: Jun. 6, 2025

(30) Foreign Application Priority Data
Dec. 18, 2024 (KR) 10-2024-0189509

(51) Int. Cl. H01M 10/663; B60H 1/00; H01M 10/613; H01M 10/625; H01M 10/6568

(52) U.S. Cl. CPC H01M 10/663; B60H 1/00278; H01M 10/613; H01M 10/625; H01M 10/6568; B60H 2001/00307; H01M 2220/20

(57) ABSTRACT

A battery cooling circuit is provided. The battery cooling circuit is configured to cool a battery provided in a vehicle by using an air conditioner system in the vehicle. The battery cooling circuit includes an air-cooled part connected in series to the air conditioner system and configured to cool a refrigerant by allowing the refrigerant to exchange heat with a first cooling fluid in the air conditioner system while flowing. The battery cooling circuit further includes a water-cooled part connected in series to a circuit configured to cool the battery. The water-cooled part is installed to communicate with the air-cooled part to allow the refrigerant to flow therein, configured to be filled with a second cooling fluid in the circuit configured to cool the battery, and configured to cool the second cooling fluid by allowing the second cooling fluid to exchange heat with the refrigerant.

### CROSS-REFERENCE TO RELATED APPLICATION(S)

This application claims priority to and the benefit of Korean Patent Application No. 10-2024-0189509 filed in the Korean Intellectual Property Office on Dec. 18, 2024, the entire contents of which are incorporated herein by reference.

### TECHNICAL FIELD

The present disclosure relates to a battery cooling circuit and a method of controlling the same, and more particularly, to a battery cooling circuit, in which the cooling circuit may be conveniently and quickly controlled by controlling the integrated components, and a method of controlling the same.

### BACKGROUND

In general, a vehicle is equipped with an air conditioning system to adjust a temperature of a vehicle interior.

The air conditioning system may maintain a comfortable interior environment by maintaining an appropriate temperature in the vehicle interior regardless of a change in outside temperature. The vehicle interior is heated or cooled by heat exchange performed by an evaporator during a process in which the refrigerant discharged by an operation of a compressor circulates back to the compressor via a condenser, a receiver drier, an expansion valve, and the evaporator.

That is, in a cooling mode in the summer season, the air conditioning system decreases a temperature and humidity in the vehicle interior as high-temperature, high-pressure gaseous refrigerant, which is compressed by the compressor, is condensed by the condenser, and the refrigerant passes through the receiver drier and the expansion valve and then is evaporated by the evaporator.

Recently, there has been a desire to develop a vehicle capable of autonomously travel. The vehicle is equipped with various types of sensors, such as radar, lidar, and global positioning system (GPS), used for autonomous driving, and an autonomous driving controller configured to control the sensors.

The vehicle capable of autonomously traveling uses a cooling device configured to prevent an engine or motor, an electrical component, and a battery including a fuel cell from being excessively heated, an air conditioning system configured to cool or heat the vehicle interior, and a separate cooling device configured to cool the autonomous driving controller that generates an (e.g., relatively large) amount of heat. Such a cooling device may increase cost and and it may be difficult to ensure a space for accommodating the cooling system in a narrow vehicle.

In addition, the size and weight of a cooling module mounted in the vehicle and layouts of connection pipes for supplying a refrigerant or a second cooling fluid to a cooling device, an air conditioning device, and an autonomous driving controller cooling device may be complicated in a narrow engine room.

### SUMMARY

The present disclosure provides a battery cooling circuit, in which components may be integrated to reduce the number of components, and the cooling circuit may be conveniently and quickly controlled by controlling the integrated components, and a method of controlling the same.

The present disclosure provides a battery cooling circuit, which is configured to cool a battery provided in a vehicle by using an air conditioner system in the vehicle. The battery cooling circuit includes an air-cooled part connected in series to the air conditioner system and configured to cool a refrigerant by allowing the refrigerant to exchange heat with a first cooling fluid in the air conditioner system while flowing, and a water-cooled part connected in series to a circuit configured to cool the battery. The water-cooled part is installed to communicate with the air-cooled part to allow the refrigerant to flow therein, configured to be filled with a second cooling fluid in the circuit configured to cool the battery, and configured to cool the second cooling fluid by allowing the second cooling fluid to exchange heat with the refrigerant.

The water-cooled part may include a partition projection protruding from an outer surface of a boundary region between the air-cooled part and the water-cooled part, and a reservoir tank coupled to the partition projection and having an accommodation space in which the second cooling fluid is accommodated.

Further, a separate O-ring may be installed between the reservoir tank and the partition projection to prevent a leak of the second cooling fluid.

In addition, a heating part may be installed in the circuit configured to cool the battery, and the heating part may be connected in parallel to the circuit and configured to heat the battery.

Further, the heating part may include a pipe having one end (e.g., first end) and the other end (e.g., second end) respectively connected to a rear end of the battery and a front end of the water-cooled part installed in the circuit, which is configured to cool the battery, in a flow direction of the second cooling fluid. The heating part may also include a PTC heater installed in the pipe, and a three-way valve installed between the other end of the pipe and the circuit at the rear end of the battery.

The present disclosure provides a method of controlling the battery cooling circuit. The method includes a first step of operating the air conditioner system, a second step of cooling the refrigerant by allowing the first cooling fluid and the refrigerant to exchange heat with each other in the air-cooled part by an operation of the air conditioner system, a third step of cooling the second cooling fluid in the water-cooled part by allowing the refrigerant, which is cooled in the air-cooled part, and the second cooling fluid to exchange heat with each other, and a fourth step of cooling the battery by the second cooling fluid cooled in the water-cooled part.

The heating part may independently operate regardless of an operation of the air conditioner system.

Further, timings in which the heating part and the water-cooled part operate may be spaced at a time interval.

In addition, the three-way valve may be opened so that the circuit at a rear end of the battery and the pipe, in which the PTC heater is installed, communicate with each other when the heating part operates.

According to the battery cooling circuit and the method of controlling the same according to the present disclosure described herein, the components may be integrated to reduce the number of components, and the cooling circuit may be controlled by controlling the integrated components to conveniently and quickly control the cooling circuit.

Further, according to the battery cooling circuit and the method of controlling the same according to the present disclosure, the battery of the vehicle may be additionally cooled by cold air in the air conditioner system installed in the vehicle, such that the energy efficiency may be improved, and the vehicle may stably travel.

### BRIEF DESCRIPTION OF THE DRAWINGS

FIG. 1 is a perspective view of a structure in which an air-cooled part and a water-cooled part of a battery cooling circuit are coupled, according to the present disclosure.

FIG. 2 is an exploded perspective view of a structure in which the air-cooled part and the water-cooled part of the battery cooling circuit are separated, according to the present disclosure.

FIG. 3 is an operational view of an operation of performing control to cool a battery by an operation of the battery cooling circuit according to the present disclosure.

FIG. 4 is an operational view of an independent operation of a heating part of the battery cooling circuit according to the present disclosure.

FIG. 5 is an operational view of simultaneous operations of an air conditioner system and the heating part of the battery cooling circuit according to the present disclosure.

### DETAILED DESCRIPTION

Hereinafter, a battery cooling circuit according to an example embodiment of the present disclosure is described with reference to the accompanying drawings.

The present disclosure is not limited to the embodiments described herein but may be implemented in various different forms. One or more of the elements in the embodiments may be selectively combined and substituted for use within the scope of the present disclosure.

In addition, unless otherwise defined and stated, the terms (including technical and scientific terms) used in the embodiments of the present disclosure may be construed as the meaning which may be commonly understood by the person with ordinary skill in the art to which the present disclosure pertains. The meanings of the commonly used terms such as the terms defined in dictionaries may be interpreted in consideration of the contextual meanings of the related technology.

In addition, the terms used in the embodiments of the present disclosure are for explaining the embodiments, not for limiting the present disclosure.

In the present disclosure, unless stated otherwise, a singular form may also include a plural form. The expression “at least one (or one or more) of A, B, and C” may include one or more combination that may be made by combining A, B, and C.

In addition, the terms such as first, second, A, B, (a), and (b) may be used to describe constituent elements of the embodiments of the present disclosure.

These terms are used for the purpose of discriminating one constituent element from another constituent element, and the nature, the sequences, or the orders of the constituent elements are not limited by the terms.

Further, when one constituent element is described as being ‘connected,’ ‘coupled,’ or ‘attached’ to another constituent element, one constituent element may be connected, coupled, or attached directly to another constituent element or connected, coupled, or attached to another constituent element through still another constituent element interposed therebetween.

In addition, the expression “one constituent element is provided or disposed above (on) or below (under) another constituent element” includes not only a case in which the two constituent elements are in direct contact with each other, but also a case in which one or more other constituent elements are provided or disposed between the two constituent elements. The expression “above (on) or below (under)” may provide a downward direction as well as an upward direction based on one constituent element.

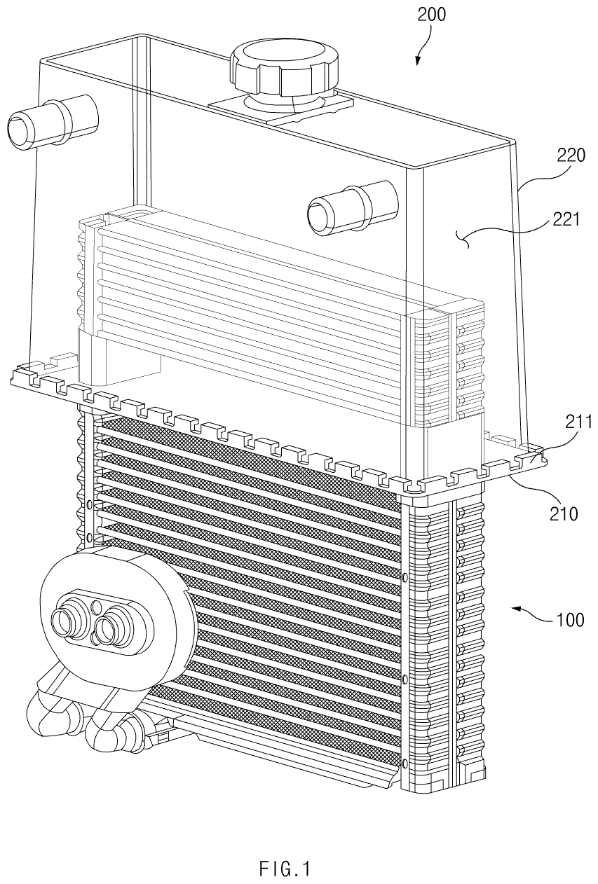

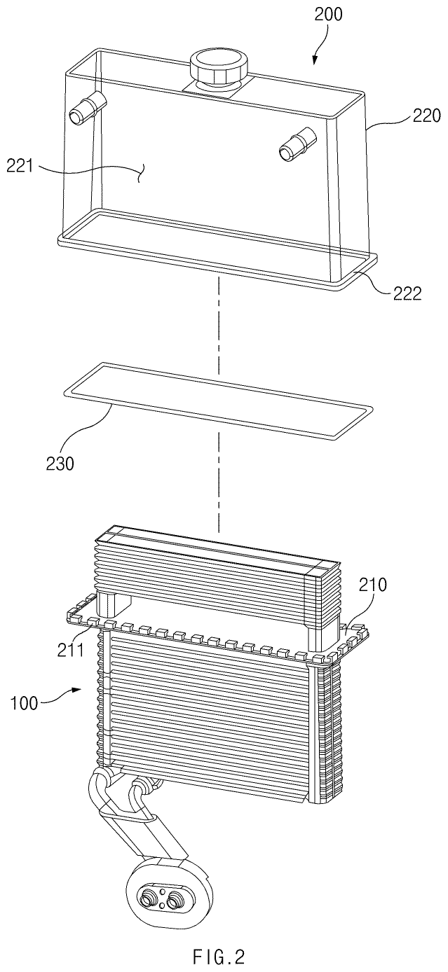

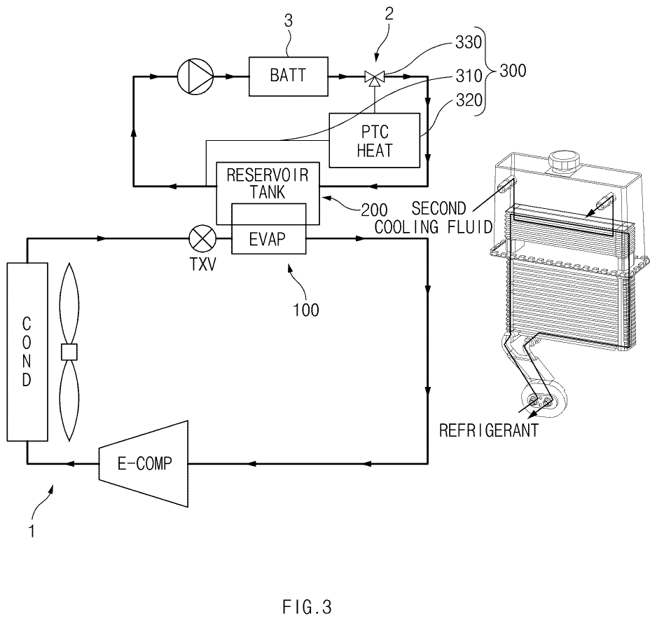

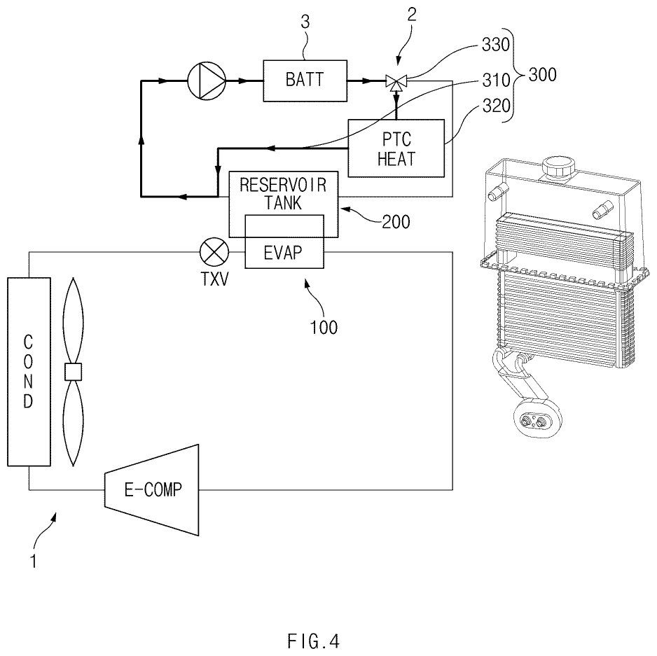

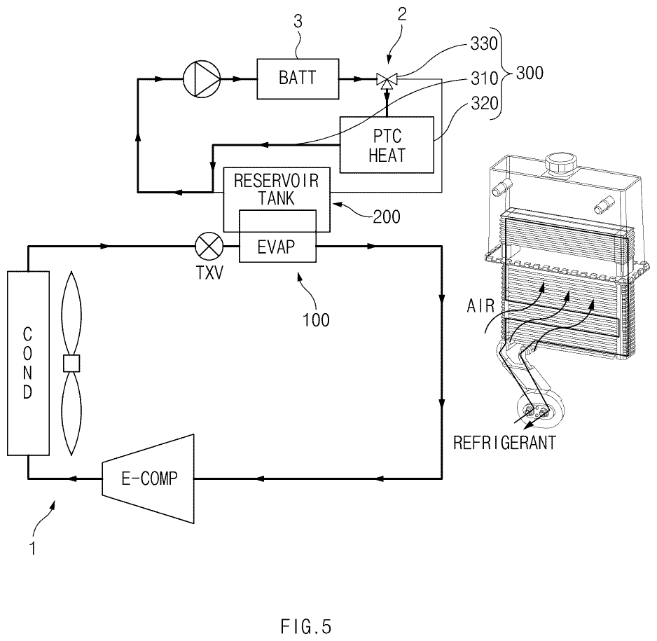

FIG. 1 is a perspective view illustrating a structure in which an air-cooled part and a water-cooled part of a battery cooling circuit are coupled according to the present disclosure, FIG. 2 is an exploded perspective view illustrating a structure in which the air-cooled part and the water-cooled part of the battery cooling circuit are separated according to the present disclosure, FIG. 3 is an operational view illustrating an operation of performing control to cool a battery by an operation of the battery cooling circuit according to the present disclosure, FIG. 4 is an operational view illustrating an independent operation of a heating part of the battery cooling circuit according to the present disclosure, and FIG. 5 is an operational view illustrating simultaneous operations of an air conditioner system and the heating part of the battery cooling circuit according to the present disclosure.

As illustrated in FIGS. 1-5, the battery cooling circuit according to the present disclosure is a battery cooling circuit capable of cooling a battery 3, which is provided in a vehicle, by using an air conditioner system 1 in the vehicle. The battery cooling circuit may include an air-cooled part 100 connected in series to the air conditioner system 1 and configured to cool a refrigerant by allowing the refrigerant to exchange heat with a first cooling fluid in the air conditioner system 1 while flowing, and a water-cooled part 200 connected in series to a circuit 2 configured to cool the battery 3. The water-cooled part 200 may be installed to communicate with the air-cooled part 100 to allow the refrigerant to flow therein, configured to be filled with a second cooling fluid in the circuit 2 configured to cool the battery 3, and configured to cool the second cooling fluid by allowing the second cooling to exchange heat with the refrigerant.

The air-cooled part 100 is connected in series to the air conditioner system 1 and configured to cool the refrigerant by performing heat exchange between the first cooling fluid, which has been cooled in the air conditioner system 1, and the refrigerant that flows in the air-cooled part 100. Further, the air-cooled part 100 is a member that allows the refrigerant, which flows in the air-cooled part 100, to be additionally cooled in an air-cooled manner.

Because the air-cooled part 100 is connected in series to the air conditioner system 1, the refrigerant present in the air-cooled part 100 may be cooled (e.g., only) by operating the air conditioner system 1, and the operation of the air conditioner system 1 may not be hindered by the air-cooled part 100.

The air-cooled part 100 may be configured as an evaporator. The evaporator is an (e.g., one) element that may constitute an interior unit of an air conditioner. The evaporator is a heat exchange device configured to cool air by using latent heat occurring when the refrigerant, which is compressed in a compressor and liquefied by radiating heat in a condenser, is evaporated. The air-cooled part 100 may be coated with aluminum, thereby increasing thermal conductivity and implementing a quick cooling process.

The operation of the air-cooled part 100 may cool the refrigerant, which flows in the evaporator, by cooling the evaporator by using air introduced while the vehicle travels.

According to another method of operating the air-cooled part 100, a separate air blower may be installed at one side of the evaporator, and the air blower may be (e.g., intentionally) operated, such that the evaporator may be cooled, and the refrigerant may be cooled.

The water-cooled part 200 is connected in series to the circuit 2 configured to cool the battery 3. The water-cooled part 200 is installed to communicate with the air-cooled part 100, and the refrigerant, which has flowed in the air-cooled part 100, flows in the water-cooled part 200. The water-cooled part 200 is filled with the second cooling fluid in the circuit 2 to cool the battery 3 in a water-cooled manner, such that heat exchange may be performed between the refrigerant and the second cooling fluid, and the second cooling fluid may be cooled.

As illustrated in FIGS. 1 and 2, the water-cooled part 200 may include a partition projection 210 protruding from an outer surface of a boundary region between the air-cooled part 100 and the water-cooled part 200, and a reservoir tank 220 coupled to the partition projection 210 and having an accommodation space 221 in which the second cooling fluid is accommodated.

The partition projection 210 is a member protruding in a width direction of the air-cooled part 100 from a boundary region between the air-cooled part 100, which is positioned at a relatively lower side, and the water-cooled part 200 positioned at a relatively upper side, e.g., above the air-cooled part 100.

The partition projection 210 has a plurality of coupling pieces 211 disposed in a circumferential direction on an upper portion of a peripheral region of the partition projection 210. The plurality of coupling pieces 211 may protrude at predetermined heights in a height direction and couple to the reservoir tank 220.

The coupling piece 211 is formed to have a cross-section with a “┐” shape, so that a catching projection 222 protruding from a periphery of a lower end of the reservoir tank 220 is inserted into the coupling pieces 211, such that the coupling pieces 211 are coupled to the reservoir tank 220.

The reservoir tank 220 is a member configured to provide an external appearance of the water-cooled part 200. The accommodation space 221 capable of accommodating the second cooling fluid is provided in the reservoir tank 220. The catching projection 222 protrudes from a peripheral surface of a lower portion of the reservoir tank 220 and is configured to be coupled to the coupling pieces 211 formed on the partition projection 210.

Further, a separate O-ring 230 may be installed between the reservoir tank 220 and the partition projection 210 to prevent a leak of the second cooling fluid. The O-ring 230 may be formed to have a shape identical to a shape of a periphery of a lower surface of the reservoir tank 220. In an example embodiment, the O-ring 230 is installed between the reservoir tank 220 and the partition projection 210, and the lower surface of the reservoir tank 220 presses on the O-ring 230 when the reservoir tank 220 is coupled to the partition projection 210, thereby maintaining sealability.

A heating part 300 may be installed in the circuit 2 configured to cool the battery 3. The heating part 300 is connected in parallel to the circuit 2 configured to cool the battery 3, and the heating part 300 heats the battery 3 when the battery 3 is cold.

As illustrated in FIGS. 3 to 5, the heating part 300 may include a pipe 310 having one end and the other end respectively connected to a rear end of the battery 3 and a front end of the water-cooled part 200 installed in the circuit 2, which is configured to cool the battery 3, in a flow direction of the second cooling fluid, and a PTC heater 320 installed in the pipe 310, and a three-way valve 330 installed between the other end of the pipe 310 and the circuit 2 at the rear end of the battery 3.

As described above, the heating part 300 may serve to improve the efficiency of the battery by heating the battery 3 when the battery 3 is cold. The heating part 300 may be connected in parallel to the circuit 2 configured to cool the battery 3.

The ends (e.g., one end and the other end) of the pipe 310, which may provide the flow path that allows the heating part 300 to be connected in parallel to the circuit 2 configured to cool the battery 3, may be respectively connected to the rear end of the battery 3 and the front end of the water-cooled part 200 installed in the circuit 2 (e.g., configured to cool the battery 3), in the flow direction of the second cooling fluid.

Because the pipe 310, which may constitute the heating part 300, is connected in parallel to the circuit 2 configured to cool the battery 3, the heating part 300 and the circuit 2 configured to cool the battery 3 may not simultaneously operate.

This is because the operation of cooling the battery 3 and the operation of heating the battery 3 (e.g., as necessary) may be mutually conflicting operations. Therefore, it is possible to prevent the operation of the heating part 300 and the operation of the circuit 2 configured to cool the battery 3 from being performed simultaneously.

The PTC heater 320 is installed in the pipe 310 and is connected in parallel to the circuit 2 configured to cool the battery 3. When it is useful (e.g., necessary) to heat the battery 3, the PTC heater 320 heats the fluid and allows the fluid to exchange heat with the cold of the battery 3, thereby heating the battery 3.

In order to prevent the operation of the heating part 300 and the operation of the circuit 2 configured to cool the battery 3 from being performed simultaneously, the three-way valve 330 is configured to be selectively opened or closed and the three-way valve 330 is installed in a region in which the pipe 310 is connected to the rear end of the circuit 2 (e.g., at the position at which the battery 3 is installed in the movement direction of the second cooling fluid).

The water-cooled part 200 is connected to the circuit 2 configured to cool the battery 3 as the three-way valve 330 is selectively opened or closed, such that the battery 3 may be cooled. Further, the circuit 2 configured to cool the battery 3 is connected to the pipe 310 of the heating part 300, such that the battery 3 may be heated.

A method of controlling the battery cooling circuit according to the present disclosure configured as described above is described below with reference to FIGS. 3 to 5.

First, as illustrated in FIG. 3, when it is useful (e.g., necessary) to cool the battery 3, the process of operating the air conditioner system 1 installed in the vehicle is performed. Thereafter, in the state in which the vehicle interior is cooled, the first cooling fluid in the air conditioner system 1 and the refrigerant in the air-cooled part 100 exchange heat with each other to cool the refrigerant.

Further, the refrigerant is further cooled by the operation of the air conditioner system 1 and the operation of the air-cooled part 100, such that the refrigerant is cooled more quickly.

The operation of the air-cooled part 100 may cool the refrigerant, which flows in the evaporator, by cooling the evaporator by using air introduced while the vehicle travels.

Further, according to another method of operating the air-cooled part 100, the (e.g., separate) air blower is installed at one side of the evaporator, and the air blower is intentionally operated, such that the evaporator may be cooled, and the refrigerant may be cooled.

Thereafter, a process in which the refrigerant cooled by the air-cooled part 100 cools the second cooling fluid in the water-cooled part 200 is performed. The second cooling fluid is cooled as the refrigerant, which is cooled by the first cooling fluid cooled in the air conditioner system 1 and (e.g., simultaneously) further cooled by the air-cooled part 100, exchanges heat with the second cooling fluid, such that the second cooling fluid is cooled.

The cooled second cooling fluid cools the heated battery 3 while flowing in the circuit 2 configured to cool the battery 3, such that the process of controlling the battery cooling circuit is completed.

Further, in this case, in order to cool the battery 3, the three-way valve 330 is opened to connect the water-cooled part 200 and the circuit 2 configured to cool the battery 3.

As illustrated in FIG. 4, in a case that a temperature of the battery 3 is determined as not reaching a (e.g., normal) range during the severe cold in the winter season (e.g., in a case that it is useful (e.g., necessary) to heat the battery 3 in order to improve the efficiency of the battery 3), the three-way valve 330 is opened to connect the circuit 2, which is configured to cool the battery 3, and the heating part 300 in which the PTC heater 320 is installed.

That is, when the heating part 300 operates, the three-way valve 330 is opened so that the circuit 2 at the rear end of the battery 3 communicates with the pipe 310 in which the PTC heater 320 is installed.

In this state, a temperature of the battery 3 is raised by heat generated from the PTC heater 320 so as to be included in a (e.g., normal) range, which may improve the efficiency of the battery 3. As illustrated in FIG. 5, the heating part 300 may independently operate regardless of the operation of the air conditioner system 1.

Further, the timings, in which the heating part 300 and the water-cooled part 200 operate, are spaced at a time interval, such that the heating part 300 and the water-cooled part 200 do not operate simultaneously, such that deterioration in energy efficiency is (e.g., substantially) prevented.

The battery cooling circuit according to the present disclosure configured as described above includes components that may be integrated to reduce the number of (e.g., other additional) components. The cooling circuit may be controlled by controlling the integrated components to conveniently and quickly control the cooling circuit, and the battery of the vehicle may be additionally cooled by cold air in the air conditioner system, such that the energy efficiency may be improved, and the vehicle may stably travel.

While the embodiments, which may be implemented by the present disclosure, have been described above, the embodiments are illustrative and not intended to limit the present disclosure. It may be appreciated by those skilled in the art that various modifications and applications, which are not described above, may be made to the present embodiment without departing from the features of the present embodiment. For example, the respective elements specifically described in the embodiments may be modified and then carried out. Further, it may be interpreted that the differences related to the modifications and applications are included in the scope of the present disclosure as provided in the claims.

What is claimed is:

1. A battery cooling circuit configured to cool a battery provided in a vehicle with an air conditioner system in the vehicle, the battery cooling circuit comprising:
an air-cooled part connected in series to the air conditioner system and configured to cool a refrigerant, the refrigerant exchanges heat with a first cooling fluid in the air conditioner system; and
a water-cooled part connected in series to a circuit configured to cool the battery, the water-cooled part is configured to
communicate with the air-cooled part for the refrigerant to flow within the air-cooled part,
be filled with a second cooling fluid, and
cool the second cooling fluid by exchanging heat with the refrigerant.

2. The battery cooling circuit of claim 1, wherein the water-cooled part comprises a partition projection protruding from an outer surface of a boundary region.

3. The battery cooling circuit of claim 2, wherein the partition projection is between the air-cooled part and the water-cooled part.

4. The battery cooling circuit of claim 2, wherein the water-cooled part further comprises a reservoir tank coupled to the partition projection.

5. The battery cooling circuit of claim 4, wherein the reservoir tank includes an accommodation space to accommodate the second cooling fluid.

6. The battery cooling circuit of claim 4, wherein an O-ring is installed between the reservoir tank and the partition projection to substantially prevent a leak of the second cooling fluid.

7. The battery cooling circuit of claim 1, wherein a heating part is installed in the circuit configured to cool the battery.

8. The battery cooling circuit of claim 7, wherein the heating part is connected in parallel to the circuit configured to cool the battery, and the heating part is configured to heat the battery.

9. The battery cooling circuit of claim 8, wherein the heating part comprises
a pipe having a first end connected to a rear end of the battery and a second end connected to a front end of the water-cooled part.

10. The battery cooling circuit of claim 9, wherein the pipe is configured to cool the battery in a flow direction of the second cooling fluid.

11. The battery cooling circuit of claim 9, wherein the heating part further comprises a PTC heater installed in the pipe.

12. The battery cooling circuit of claim 9, wherein the heating part further comprises a three-way valve installed between the second end of the pipe and the rear end of the battery.

13. A method of controlling a battery cooling circuit, wherein the battery cooling circuit is configured to cool a battery provided in a vehicle by using an air conditioner system in the vehicle, the battery cooling circuit includes
an air-cooled part connected in series to the air conditioner system and configured to cool a refrigerant, the refrigerant exchanges heat with a first cooling fluid in the air conditioner system,
a water-cooled part connected in series to a circuit is configured to cool the battery, the water-cooled part is configured to communicate with the air-cooled part, be filled with a second cooling fluid, and cool the second cooling fluid by exchanging heat with the refrigerant, and
a heating part installed in the circuit configured to cool the battery, and the heating part is connected in parallel to the circuit and configured to heat the battery, wherein the method comprises:
operating the air conditioner system;
cooling the refrigerant, wherein the first cooling fluid and the refrigerant exchange heat in the air-cooled part by an operation of the air conditioner system;
cooling the second cooling fluid in the water-cooled part, wherein the refrigerant cooled in the air-cooled part and the second cooling fluid exchange heat; and
cooling the battery with the second cooling fluid cooled in the water-cooled part.

14. The method of claim 13, wherein the heating part operates independent of an operation of the air conditioner system.

15. The method of claim 13, wherein the heating part and the water-cooled part operate at spaced time intervals.

16. The method of claim 13, wherein the heating part comprises a pipe having a first end connected to a rear end of the battery and a second end connected to a front end of the water-cooled part.

17. The method of claim 16, wherein the heating part comprises a PTC heater installed in the pipe.

18. The method of claim 13, wherein the water-cooled part comprises a partition projection protruding from an outer surface of a boundary region.

19. The method of claim 18, wherein the partition projection is between the air-cooled part and the water-cooled part.

20. The method of claim 19, wherein the water-cooled part further comprises a reservoir tank coupled to the partition projection.
